(19) United States
(12) Patent Application Publication
(10) Pub. No.: US 2013/0024388 A1
(43) Pub. Date: Jan. 24, 2013

(54) Computer-Implemented System And Method For Modeling Contractual Terms As Structured Data For License Compliance Analysis

(71) Applicant: Kurt G. Kolb, Clyde Hill, WA (US)

(72) Inventor: Kurt G. Kolb, Clyde Hill, WA (US)

(21) Appl. No.: 13/555,015

(22) Filed: Jul. 20, 2012

Related U.S. Application Data
(60) Provisional application No. 61/510,944, filed on Jul. 22, 2011.

(51) Int. Cl. G06Q 99/00

(52) U.S. Cl. 705/317

(57) ABSTRACT

A computer-implemented system and method for modeling contractual terms as structured data for license compliance analysis is provided. A set of electronically-stored expressions is defined. Each expression includes parseable contract terminology and a meaning associated with the contract terminology. A license for a product is converted into structured data. Terms of use included in the license are parsed. The parsed terms of use are matched against the parseable contract terminology in the set of expressions. For each expression whose parseable contract terminology was matched to a parsed term of use, the associated meaning is assembled into a schematized data structure that represents the product license. Compliance of an installed base of the product is evaluated against each meaning in the schematized data structure.

### CROSS-REFERENCE TO RELATED APPLICATION

This non-provisional patent application claims priority under 35 U.S.C. §119(e) to U.S. Provisional Patent Application, Ser. No. 61/510,944, filed Jul. 22, 2011, the disclosure of which is incorporated by reference.

### FIELD

The present invention relates in general to automated license compliance analysis and, in particular, to a computer-implemented system and method for modeling contractual terms as structured data for license compliance analysis.

### BACKGROUND

In simplest form, licenses are a form of legal contract used to grant permission to a licensee to use the property of a licensor in a manner that is defined in the license. Licensing is widely used throughout the software industry to dictate how a software product is to be used by an end-user, including limits on the use of the software product, the number of installations allowed and any terms of distribution. By convention, the actual user of software is ultimately bound to the terms of a software license, sometimes expressed via what may be variously known as an End-User License Agreement (EULA), Terms of Use (TOU) or Product Usage Rights (PUR), although other license names are also used.

Commercial software, as opposed to so-called open source software, is generally licensed under one of two general schemes. Software purchased as standalone products are typically offered with “shrink wrap” licenses, an allusion to the plastic wrapping material used to enclose boxes containing the media upon which the software is distributed. Acceptance of the license terms by an end-user is inferred by the physical act of unwrapping the boxes or breaking a seal. Software purchased in conjunction with hardware, such as an operating system pre-installed on a desktop computer system, is offered under an OEM license. The pre-installed software is treated as part of a “bundle” of licensed goods and the use of the hardware constitutes software license acceptance. Still other software licensing schemes are known.

Software licensing is applied to all levels of intended software usage, including individual at-home users, small businesses, private and public companies, educational and governmental institutions, and multi-national corporations. License terms can be offered through adhesion contracts, where the end-user is expected to accept the license without having any say in the terms, to individually-negotiated contracts in which both parties, the end-user and the software publisher, agree to specific contract terms.

The adhesion-style of contract dominates software licensing and vastly outnumbers end-user-tailored contracts. Notwithstanding the inherently one-sided nature of adhesion contracts, a software publisher may offer countless variations of a software license for the same product or suite of products with terms of use that apply under differing circumstances and pricing schemes that are based on seemingly tacit provisions of which the end-user is ultimately unaware. End-users infrequently examine the terms of their software license, partly due to the lack of appreciable negotiating power, but mostly because of the complexity and technicalities built into the legal language itself. As a result, the average end-user is perhaps only superficially familiar with, if at all, the terms of use and the tendency has become for end-users to over-license their software to ensure that, at a minimum, they are compliant with the license terms, at least to the extent that they are understood.

In a business environment, information technology departments are generally charged with the responsibility of managing and optimizing computer assets through planned asset purchase, installation, maintenance, usage, and eventual disposal. Compliance with the terms of product licensing is obligatory and a failure to ensure such compliance could result in serious repercussions, including potentially jeopardizing the ability of the organization to use a licensor's products in the future. The importance of ensuring compliance has recently been underscored by the publication and adoption of a set of international standards, ISO/IEC 19770, that enable an organization to prove that their efforts at performing software asset management are to a standard sufficient to satisfy corporate governance requirements and ensure effective overall support for information technology management. These international standards specify the use of software identification tags and licensing entitlement tags that are to be included with software products, yet the use of tags alone is insufficient to ensure license term compliance.

Therefore, a need exists to allow end-users to determine software license compliance based on the terms of use under which their software product usage has been licensed.

### SUMMARY

The computer systems and their installed product base of software and hardware within an organization are dynamically discovered from a trusted position on a network. The discovery tool grabs product tags and applies heuristics against schematized representations of software licenses to thereby determine compliance and related considerations. By operating from a trusted network through, for instance, a directory services infrastructure, the product tags can be monitored both internally and with respect to changes that are flowing inside and outside of the network. Thus, activity of the devices and services that interact with the network are also identified and tracked.

An embodiment provides a computer-implemented system and method for modeling contractual terms as structured data for license compliance analysis. A set of electronically-stored expressions is defined. Each expression includes parseable contract terminology and a meaning associated with the contract terminology. A license for a product is converted into structured data. Terms of use included in the license are parsed. The parsed terms of use are matched against the parseable contract terminology in the set of expressions. For each expression whose parseable contract terminology was matched to a parsed term of use, the associated meaning is assembled into a schematized data structure that represents the product license. Compliance of an installed base of the product is evaluated against each meaning in the schematized data structure.

The foregoing approach, in combination with a discovery tool operating from a position of organizational trust within a network infrastructure, allows analysis of a wide range of devices and services, including conventional network-interconnected computer systems, mobile devices and cloud services, without requiring dedicated management agents on each device or direct access to cloud services interacting with the network. Moreover, this approach enables the capture of data by security appliances and firewalls, as well as local servers.

In addition, this approach of dynamic discovery combines usage profiles that contain, for instance, end-users (people) and their devices, to data access and creates a more granular set of metadata on data that can be used to solve issues on data sovereignty, data security, and so forth. As well, the approach combines activity profiles that contain, for instance, devices and their end-users (people), which can be used for security analytics that can include generating a warning if changes from the norm occur, even if authenticated. Still further advantages of this approach to dynamic discovery and asset management exist.

Still other embodiments will become readily apparent to those skilled in the art from the following detailed description, wherein are described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing a computer-implemented system for modeling contractual terms as structured data for license compliance analysis in accordance with one embodiment.

FIG. 2 is a flow diagram showing a computer-implemented method for modeling contractual terms as structured data for license compliance analysis in accordance with one embodiment.

FIG. 3 is a schema diagram showing, by way of example, software license compliance analysis respectively for use with the system and method of FIGS. 1 and 2.

### DETAILED DESCRIPTION

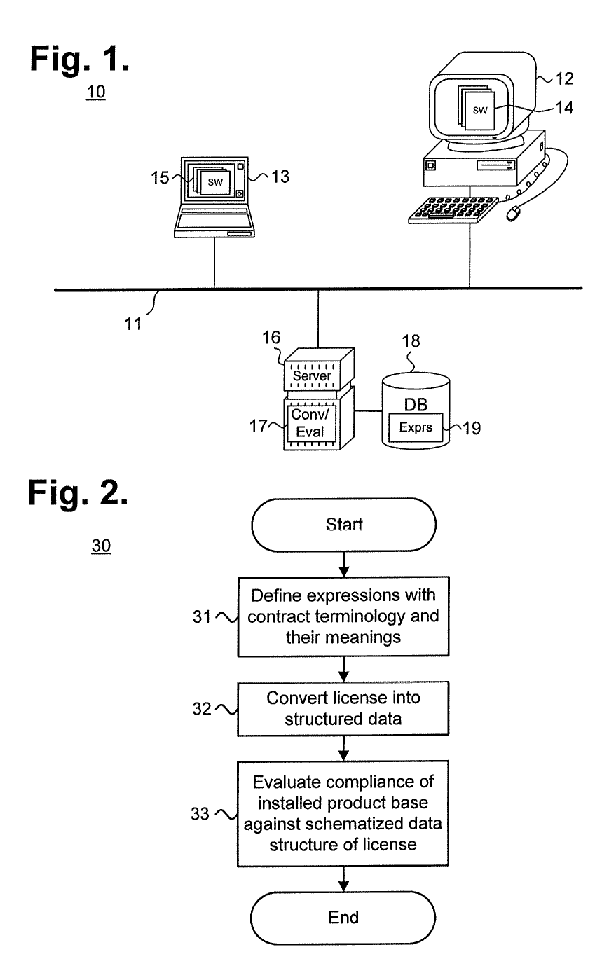

Identifying and licensing the intellectual property rights underlying products and services, particularly in the high technology and computer industries, has become infinitely complex due to the integration and ubiquity of technology into virtually every facet of modern life. Conversely, the need to address these complexities puts both businesses and consumers at a point where they are using products and services, but have no practical or effective way to understand what they are using and how their use compares with the terms and conditions of the licenses they hold. The written contract language that expresses the metes and bounds of licensed use of products and services can be parsed and schematized to empower end-users with the ability to both understand and comply with such licenses. FIG. 1 is a block diagram showing a computer-implemented system 10 for modeling contractual terms as structured data for license compliance analysis in accordance with one embodiment. The system 10 operates on individual computer systems, such as a personal computer 12, laptop computer 13, and server 16, and include components conventionally found in general purpose programmable computing devices, such as a central processing unit, memory, input/output ports, network interfaces, and non-volatile storage, although other components are possible, as well as other types of computer systems, including network computers, tablet computers, smart phones and similar mobile devices, and so forth.

An end-user, whether an individual or entity, such as a small businesses, private and public companies, educational and governmental institutions, and multi-national corporations, operates an installed base of one or more computer systems, such as personal computer 12 and laptop computer 13, which can be interconnected via a network infrastructure 11. The network infrastructure 11 can be local or wide area, or a combination of both. In addition, the network infrastructure 11 can be wired, wireless, or both. The network infrastructure 11 can also be virtualized as a “cloud” that delivers end-user computing and storage services without tie-ins to specific computing components. The computer systems 12, 13 respectively have installed one or more software products (“SW”) 14, 15 that are subject to some form of written or similarly formalized license agreements that spell out license terms and conditions of use.

The end-user is ultimately responsible for compliance with the terms and conditions of the license agreements. A server 16 is coupled to a storage device in which a database (“DB”) 18 is maintained. The database 18 stores a set of expressions 19 that are used by a conversion and evaluation application 17 to extract the details of license agreements, such as the licenses for the software products 14, 15, and convert those details into schematized structured data. The server 16 can then inventory and evaluate the computer systems 12, 13 to determine what license terms apply and whether the software products 14, 15 are in compliance with those terms.

The licenses are modeled by converting their contractual terms into structured data that can be used in automated license compliance analysis. FIG. 2 is a flow diagram showing a computer-implemented method 30 for modeling contractual terms as structured data for license compliance analysis in accordance with one embodiment. The method 30 is performed as a series of process steps by a server 16 (shown in FIG. 1) or other computing device.

Initially, a framework that ties a business “Rule Book” of the contractual terms into the overall system 10 is formed by defining a set of expressions 18 that are electronically stored into the database 19 (step 31). Each expression contains contract terminology that is specified as parseable content, which is paired with a meaning associated with that contract terminology. The stored meaning captures the understanding of the license terminology, such as provided by a person with subject matter expertise, for instance, an attorney, who has separately evaluated the license terms and determined their limits and permissions of use, as well as other considerations. In addition, alternative formulations of contract terminology that shares the same meaning can be stored in the set of expressions 18 to allow different formulations of licenses to be consistently understood and analyzed.

In one embodiment, the “Rule Book” is designed as an open-ended framework, so that more expressions can be added into the system 10, without requiring programming changes to the underlying compliance analysis engine. This approach enables a business person to create a rule that is saved into the database 18 as an expression 19, and then have the system 10 use the expression during compliance analysis. Each expression 19 is implemented using XML or other forms of extensible markup language. Other implementations of a “Rule Book” or similar collection of rules and expressions are possible.

The creation of the set of expressions 18 enables a license to be converted into schematized structured data (step 32). During conversion, the license is first parsed to identify included terms of use, which are then matched against the parseable contract terminology in the set of expressions 18. To enable parsing, the contract terminology in each expression 18 is built as a construct that combines tokens and logic, which together express the complexity inherent in contract paragraphs, sentences, clauses, and terms. Tokens are first identified within the terms of use in a license. Thereafter, the meaning for each expression whose tokens were matched to a parsed term of use is identified. The accompanying logic is evaluated to determine the appropriate meaning to assign the terms of use. Finally, the associated meanings of all matched terms of use in the license are assembled into a schematized data structure that represents the product license in a uniform and data-processable form. The schematized data structure is implemented in a form of relational database representation for use with a structured query language, such as SQL. In one embodiment, the expressions are implemented in the extensible markup language for purposes of transportability and are converted into the schematized data structure for use in evaluating license compliance. The conversion process can be performed on a plurality of licenses to enable evaluation of an entire suite of products.

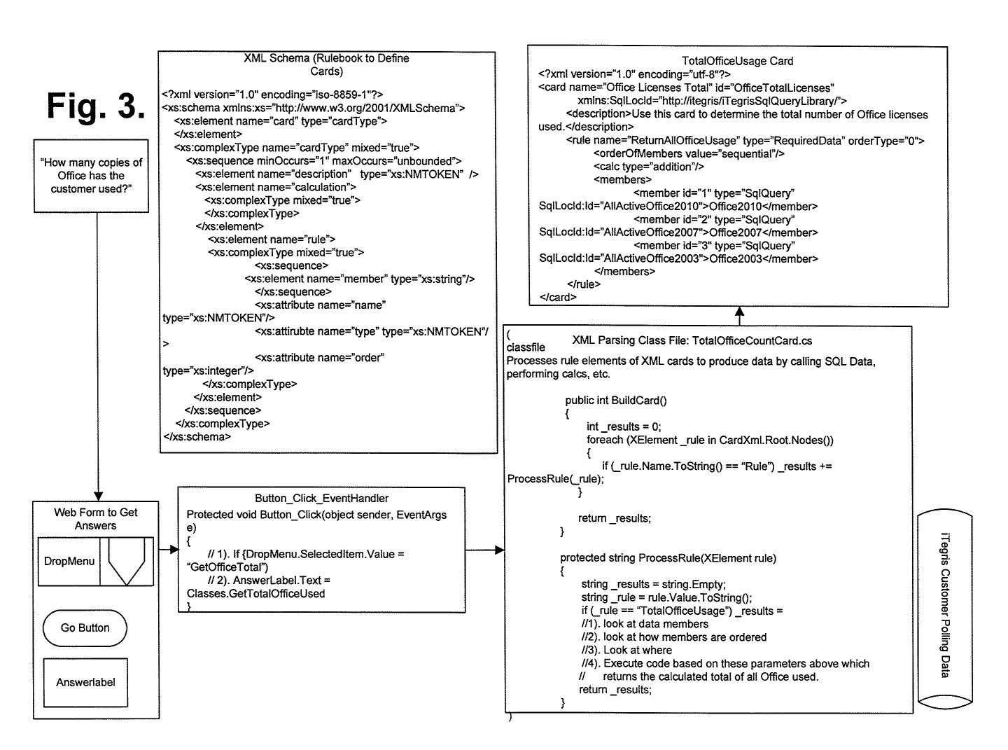

Once converted, the license can be evaluated by using the schematized data structure to determine compliance of the end-user's installed product base with the license's terms of use (step 33). FIG. 3 is a schema diagram showing, by way of example, software license compliance analysis respectively for use with the system and method of FIGS. 1 and 2. The computer systems that constitute the installed base of end-user devices and their deployed software and hardware products are first identified through a process of dynamic discovery, such as described in commonly-assigned U.S. Provisional Patent Application, entitled “Computer-Implemented System and Method for Identifying Computational Entities in a Networked Security Realm,” Ser. No. 61/615,874, filed Mar. 26, 2012, the disclosure of which is incorporated by reference. The systems and their installed base of software and hardware can be determined through various approaches, including by using conventional client-based management agents, by performing a top-down trace of a secure domain directory service, such as Active Directory, through asynchronous callback methods registered with a network management infrastructure that provide near real time updates, or other methodologies. In one embodiment, deployed product usage patterns are obtained by sequencing and scheduling discovery tracing optimally timed to avoid negatively impacting the organization. Consequently, deep scans of all components on the network all the time are avoided.

Following dynamic discovery, various terms of use can be analyzed. For instance, the actual usage of the software products 14, 15 (shown in FIG. 1) can be analyzed against a license term specifying an intended use of the product. Similarly, the number of copies of the software products 14, 15 can be determined and compared to a license term setting a permissible number of copies. In the same vein, an end-user might find that merely knowing the actual usage or permissible number of copies provided in a license is in excess of their needs; unused software products can be removed to avoid unnecessary license fees. Furthermore, the findings from compliance analysis can themselves be modeled, such as described in commonly-assigned U.S. Provisional Patent Application, entitled “System and Method for Modeling Deployed Software and Services Usage and License Rights,” Ser. No. 61/615,882, filed Mar. 26, 2012, the disclosure of which is incorporated by reference. Still other forms of models, analyses and uses are possible.

While the invention has been particularly shown and described as referenced to the embodiments thereof, those skilled in the art will understand that the foregoing and other changes in form and detail may be made therein without departing from the spirit and scope of the invention.

What is claimed is:

1. A computer-implemented system for modeling contractual terms as structured data for license compliance analysis, comprising:
a database comprising a set of electronically-stored expressions, each expression comprising parseable contract terminology and a meaning associated with the contract terminology; and
an executable conversion application configured to convert a license for a product into structured data, comprising:
a parser module configured to parse terms of use comprised in the license and to match the parsed terms of use against the parseable contract terminology in the set of expressions; and
a schema module configured to, for each expression whose parseable contract terminology was matched to a parsed term of use, assemble the associated meaning into a schematized data structure that represents the product license; and
an executable evaluation application configured to evaluate compliance of an installed base of the product against each meaning in the schematized data structure.

2. A system according to claim 1, further comprising:
the database including one or more alternative formulations of the parseable contract terminology in the set of expressions; and
the parser further configured to test each of the alternative formulations of the parseable contract terminology against the parsed terms of use.

3. A system according to claim 1, further comprising:
the database comprising each of the expressions built as a construct combining tokens and logic; and
the parser further configured to identify the tokens within the parsed terms of use and to evaluate the logic comprised in each expression that comprises matched tokens.

4. A system according to claim 1, further comprising:
the database specifying an intended use the product as one such meaning in the set of expressions; and
the executable evaluation application further configured to analyze actual usage of the installed base of the products versus the intended use.

5. A system according to claim 1, further comprising:
the database specifying a permissible number of copies of the product as one such meaning in the set of expressions; and
the executable evaluation application further configured to analyze the installed base of the products versus the permissible number of copies.

6. A system according to claim 1, further comprising:
the executable evaluation application further configured to identify one or more of actual usage and permissible number of copies of the product based on the schematized data structure.

7. A system according to claim 1, further comprising:
the executable evaluation application further configured to evaluate a plurality of licenses for a suite of products against the installed base of the products.

8. A system according to claim 1, further comprising:
a rule book assembling the set of expressions; and
the database supplementing the rule book with further expressions, which extend the parseable contract terminology and their associated meanings.

9. A system according to claim 1, wherein each of the expressions are implemented in an extensible markup language and the schematized data structure is implemented in a relational database representation.

10. A computer-implemented method for modeling contractual terms as structured data for license compliance analysis, comprising the steps of:
defining a set of electronically-stored expressions, each expression comprising parseable contract terminology and a meaning associated with the contract terminology;
converting a license for a product into structured data, comprising:
parsing terms of use comprised in the license;
matching the parsed terms of use against the parseable contract terminology in the set of expressions; and
for each expression whose parseable contract terminology was matched to a parsed term of use, assembling the associated meaning into a schematized data structure that represents the product license; and
evaluating compliance of an installed base of the product against each meaning in the schematized data structure,
wherein the steps are performed on a suitably-programmed computer.

11. A method according to claim 10, further comprising the steps of:
including one or more alternative formulations of the parseable contract terminology in the set of expressions; and
testing each of the alternative formulations of the parseable contract terminology against the parsed terms of use.

12. A method according to claim 10, further comprising the steps of:
building each of the expressions as a construct combining tokens and logic;
identifying the tokens within the parsed terms of use; and
evaluating the logic comprised in each expression that comprises matched tokens.

13. A method according to claim 10, further comprising the steps of:
specifying an intended use the product as one such meaning in the set of expressions; and
analyzing actual usage of the installed base of the products versus the intended use.

14. A method according to claim 10, further comprising the steps of:
specifying a permissible number of copies of the product as one such meaning in the set of expressions; and
analyzing the installed base of the products versus the permissible number of copies.

15. A method according to claim 10, further comprising the step of:
identifying one or more of actual usage and permissible number of copies of the product based on the schematized data structure.

16. A method according to claim 10, further comprising the step of:
evaluating a plurality of licenses for a suite of products against the installed base of the products.

17. A method according to claim 10, further comprising the steps of:
assembling the set of expressions into a rule book; and
supplementing the rule book with further expressions, which extend the parseable contract terminology and their associated meanings.

18. A method according to claim 10, further comprising the step of:
implementing each of the expressions in an extensible markup language and the schematized data structure in a relational database representation.

19. A non-transitory computer readable storage medium storing code for executing on a computer system to perform the method according to claim 10.

20. A computer-implemented apparatus for modeling contractual terms as structured data for license compliance analysis, comprising the steps of:
means for defining a set of electronically-stored expressions, each expression comprising parseable contract terminology and a meaning associated with the contract terminology;
means for converting a license for a product into structured data, comprising:
means for parsing terms of use comprised in the license;
means for matching the parsed terms of use against the parseable contract terminology in the set of expressions; and
means for assembling the associated meaning into a schematized data structure that represents the product license for each expression whose parseable contract terminology was matched to a parsed term of use; and
means for evaluating compliance of an installed base of the product against each meaning in the schematized data structure.
